(19) United States
(12) Patent Application Publication
(10) Pub. No.: US 2012/0211136 A1
(43) Pub. Date: Aug. 23, 2012

(54) TIRE WITH INNER CORE

(75) Inventors: MEHMET DONDURUR, DHAHRAN (SA); AHMET Z. SAHIN, DHAHRAN (SA)

(73) Assignee: KING FAHD UNIVERSITY OF PETROLEUM AND MINERALS, DHAHRAN (SA)

(21) Appl. No.: 13/032,294

(22) Filed: Feb. 22, 2011

(51) Int. Cl. B60C 7/00; B60C 5/00

(52) U.S. Cl. 152/311

(57) ABSTRACT

The tire with an inner core includes a resilient annular shell similar to a conventional vehicle tire, and an annular inner core disposed therein, allowing the vehicle to continue traveling if the annular shell is damaged. The resilient annular shell includes a central portion and a pair of sidewalls extending therefrom. The annular inner core is disposed within the resilient annular shell and includes an inner annular edge, a pair of side annular edges, and an outer annular edge. In one embodiment, the outer annular edge of the annular inner core contacts the interior surface of the central portion of the resilient annular shell, and the pair of side annular edges are spaced apart from the interior surfaces of the pair of sidewalls of the resilient annular shell for receiving pressurized air therebetween. Preferably, the annular inner core is formed from a wire-reinforced resilient material, such as rubber.

### BACKGROUND OF THE INVENTION

1. Field of the Invention

The present invention relates generally to vehicle tires, and particularly to a tire with inner core for allowing a vehicle to continue traveling when damage has occurred to the tire.

2. Description of the Related Art

Conventional pneumatic vehicle tires consist of an outer casing, which is given desired load-bearing capacity and elasticity by pressurized air pumped into the casing or into an inner tube fitted within the casing. Unfortunately, such pneumatic tires are subject to explosive decompression, when punctured, which may create serious hazards for the occupants of the vehicle or of nearby vehicles, especially if the puncture occurs while the vehicle is traveling at high speed or on a crowded road, such as a freeway. Numerous attempts have been made heretofore to overcome these disadvantages by filling the tire casing with other materials.

Fully solid tires, as are commonly used in race cars, have the disadvantage of extreme weight, which creates severe strain on the engine of the vehicle. Tires being filled with relatively lightweight materials, such as elastic foam, suffer from the tendency of the foam to become damaged at the same time the outer casing of the tire is damaged, or from the tendency to not properly expand and fill the outer casing, thus creating unsafe driving conditions in the event of tire damage.

Thus, a tire with an inner core solving the aforementioned problems is desired.

### SUMMARY OF THE INVENTION

The tire with an inner core includes a resilient annular shell similar to a conventional vehicle tire, and an annular inner core disposed therein, thus allowing the vehicle to continue traveling if the resilient annular shell is damaged. The resilient annular shell includes a central portion and a pair of sidewalls extending therefrom, as is conventionally known. An exterior surface of the central portion is adapted for contacting a road surface and preferably has tire tread formed thereon. Inner annular edges of the pair of sidewalls are adapted for fluid-tight mounting on a wheel hub, as is conventionally known.

The annular inner core is disposed within the resilient annular shell and includes an inner annular edge, a pair of side annular edges and an outer annular edge. The inner annular edge is adapted for mounting about the wheel hub. In one embodiment, the outer annular edge of the annular inner core contacts the interior surface of the central portion of the resilient annular shell, and the pair of side annular edges are respectively spaced apart from the interior surfaces of the pair of sidewalls of the resilient annular shell for receiving pressurized air therebetween. Preferably, the annular inner core is formed from a wire-reinforced resilient material, such as rubber. Further, an annular channel may be formed substantially centrally within the annular inner core for receiving a volume of pressurized air.

In an alternative embodiment, the outer annular edge and the pair of side annular edges of the annular inner core, respectively, make fluid-tight contact with the interior surfaces of the central portion and the pair of sidewalls of the resilient annular shell. In this embodiment, the annular inner core is also preferably formed from a wire-reinforced resilient material, such as rubber. An annular channel is also preferably formed substantially centrally within the annular inner core for receiving a volume of pressurized air.

In another alternative embodiment, the pair of side annular edges and the outer annular edge of the annular inner core are all respectively spaced apart from the interior surfaces of the pair of sidewalls and the central portion of the resilient annular shell for receiving pressurized air therebetween. In this embodiment, the annular inner core is also preferably formed from a wire-reinforced resilient material, such as rubber. An annular channel is also preferably formed substantially centrally within the annular inner core for receiving a volume of pressurized air.

These and other features of the present invention will become readily apparent upon further review of the following specification and drawings.

### BRIEF DESCRIPTION OF THE DRAWINGS

FIG. 1 is an environmental perspective view in section showing a wheel having a first embodiment of a tire with an inner core according to the present invention mounted thereon.

FIG. 2 is an environmental, partial front view in section of the wheel and tire with an inner core of FIG. 1.

FIG. 3 is an environmental, partial front view in section of an alternative embodiment of a tire with an inner core according to the present invention.

FIG. 4 is an environmental, partial front view in section of another alternative embodiment of a tire with an inner core according to the present invention.

FIG. 5 is an environmental, partial front view in section of still another alternative embodiment of a tire with an inner core according to the present invention.

Similar reference characters denote corresponding features consistently throughout the attached drawings.

### DETAILED DESCRIPTION OF THE PREFERRED EMBODIMENTS

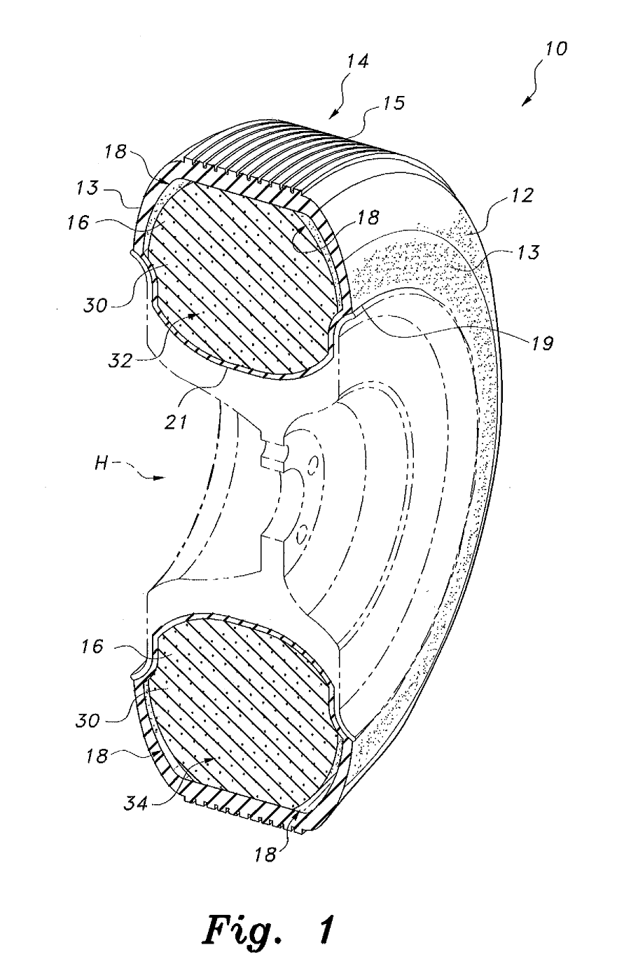

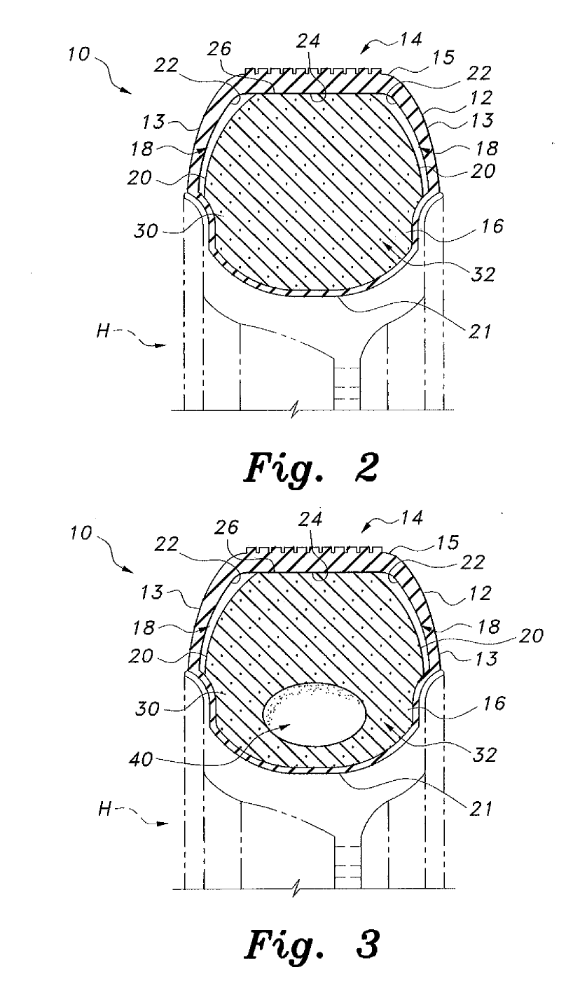

Referring now to FIGS. 1 and 2, in a first embodiment, the tire with an inner core 10 includes a resilient annular shell 12, similar to a conventional vehicle tire, and an annular inner core 16 disposed therein, thus allowing the vehicle to continue traveling if the resilient annular shell 12 is damaged (i.e., the vehicle may continue traveling to seek repair under conditions in which a conventional tire would be flat and inoperative).

The resilient annular shell 12 includes a central portion 15 and a pair of sidewalls 13 extending therefrom, as is conventionally known in vehicle tires. An exterior surface of the central portion 15 is adapted for contacting a road surface and preferably has tire tread 14 formed thereon. Inner annular edges 19 of the pair of sidewalls 13 are adapted for fluid-tight mounting on a wheel hub H, as is conventionally known.

As best shown in FIG. 2, the annular inner core 16 is disposed within the resilient annular shell 12 and includes an inner annular edge 21, a pair of side annular edges 20 and an outer annular edge 26. Prior to mounting within the shell 12, the annular inner core 16 may have a substantially toroidal shape, the outer annular edge 26 being the largest diameter portion of the torus and the inner annular edge 21 being the smallest diameter portion of the torus.

The inner annular edge 21 is adapted for mounting about the wheel hub H, preferably in a fluid-tight fashion. As best seen in FIG. 2, the outer annular edge 26 of the annular inner core 16 contacts the interior surface 24 of the central portion 15 of the resilient annular shell 12, and the pair of side annular edges 20 are respectively spaced apart from the interior surfaces 22 of the pair of sidewalls 13 of the resilient annular shell 12 for receiving pressurized air in the gaps 18 formed therebetween. Preferably, the outer annular edge 26 of the annular inner core 16 makes fluid-tight contact with the interior surface 24 of the central portion 15 of the resilient annular shell 12.

The annular inner core 16 is formed from a resilient material, such as soft rubber. Preferably, the annular inner core 16 is formed from a wire-reinforced resilient material, such as soft rubber 30 having a wire mesh 32 embedded therein, as is well-known in the field of reinforced tires, for example. The air held within gaps 18 provides enhanced shock absorption for the tire 10. Preferably, during manufacture, the annular inner core 16 is at least partially compressed during insertion within shell 12. Thus, if the shell 12 is breached along the sides, causing the pressurized air within one or both of gaps 18 to be released, the annular inner core 16 will decompress and expand to at least partially fill the gaps.

In the embodiment of FIG. 3, the configuration of the external tire 10 and the inner core 16 are identical to the embodiment of FIGS. 1 and 2, except that an annular channel 40 is formed substantially centrally through the annular inner core 16 for receiving a volume of pressurized air. Although shown as being substantially oval, it should be understood that the annular channel 40 may have any desired shape, such as circular or a configuration corresponding to the overall configuration of the annular inner core 16. If the shell 12 is breached along the sides, thus causing the pressurized air within one or both of gaps 18 to be released, the pressurized air held within channel 40 will cause the annular inner core 16 to expand to at least partially fill the gaps. Preferably, the volume of annular channel 40 is approximately 20% of the volume of the annular inner core 16.

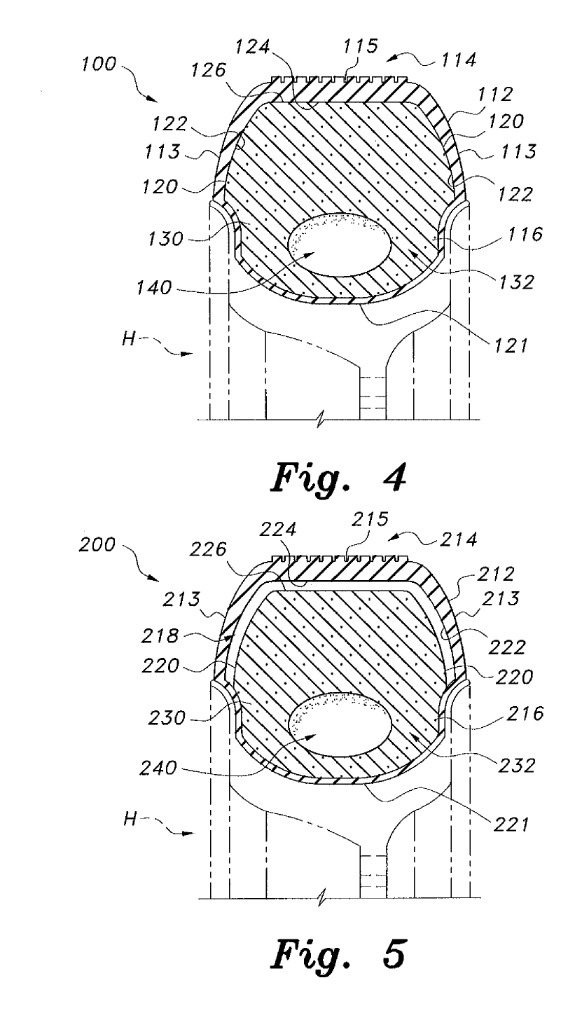

In the alternative embodiment of FIG. 4, the tire with an inner core 100 similarly includes a resilient annular shell 112 and an annular inner core 116 disposed therein. The resilient annular shell 112 includes a central portion 115 and a pair of sidewalls 113 extending therefrom. An exterior surface of the central portion 115 is adapted for contacting a road surface and preferably has tire tread 114 formed thereon.

The annular inner core 116 is disposed within the resilient annular shell 112 and includes an inner annular edge 121, a pair of side annular edges 120 and an outer annular edge 126. The outer annular edge 126 and the pair of side annular edges 120 of the annular inner core 116 respectively make fluid-tight contact with the interior surfaces 124, 122 of the central portion 115 and the pair of sidewalls 113 of the resilient annular shell 112, respectively. As in the previous embodiments, the annular inner core 116 is also preferably formed from a wire-reinforced resilient material, such as soft rubber 130 having a wire mesh 132 embedded therein. An annular channel 140 is also preferably formed substantially centrally within the annular inner core 116 for receiving a volume of pressurized air. Regardless of the state of the shells 12, 112, the inner cores 16, 116 of the above embodiments will provide support for the resilient annular shell 12, 112 in all travel conditions.

In the further alternative embodiment of FIG. 5, the tire with an inner core 200 similarly includes a resilient annular shell 212 and an annular inner core 216 disposed therein. The resilient annular shell 212 includes a central portion 215 and a pair of sidewalls 213 extending therefrom. An exterior surface of the central portion 215 is adapted for contacting a road surface and preferably has tire tread 214 formed thereon.

The annular inner core 216 is received within the resilient annular shell 212 and includes an inner annular edge 221, a pair of side annular edges 220, and an outer annular edge 226. The pair of side annular edges 220 and the outer annular edge 226 are all respectively spaced apart from the interior surfaces 222, 224 of the pair of sidewalls 213 and the central portion 215 of the resilient annular shell 212 for receiving pressurized air in the gap 218 formed between annular inner core 216 and the resilient annular shell 212. As in the previous embodiments, the annular inner core 216 is also preferably formed from a wire-reinforced resilient material, such as soft rubber 230 having a wire mesh 232 embedded therein. An annular channel 240 is also preferably formed substantially centrally within the annular inner core 216 for receiving a volume of pressurized air.

In the embodiment of FIG. 5, the annular inner core 216 will support the shell 212 when shell 212 is breached, thus causing the shell 212 to collapse against the core 216. As noted above, the gap 218 and the annular channel 240 both preferably contain pressurized air. Thus, if the shell 212 is breached and the air contained within gap 218 is released, the pressurized air contained within the annular channel 240 will cause the inner core 216 to expand outwardly, thus better supporting the shell 212 until repairs can be made.

It is to be understood that the present invention is not limited to the embodiments described above, but encompasses any and all embodiments within the scope of the following claims.

We claim:

1. A tire with an inner core, comprising:
a resilient annular shell having a central portion and a pair of sidewalls extending therefrom, the central portion and the pair of sidewalls each having respective interior and exterior surfaces, the exterior surface of the central portion being adapted for contacting a road surface, the pair of sidewalls having inner annular edges adapted for fluid-tight mounting on a wheel hub; and
an annular inner core disposed within the resilient annular shell and having an inner annular edge, a pair of side annular edges, and an outer annular edge, the inner annular edge of the inner core being adapted for mounting about the wheel hub, the outer annular edge contacting the interior surface of the central portion of the resilient annular shell, the pair of side annular edges of the inner core being spaced apart from the interior surfaces of the pair of sidewalls of the resilient annular shell for receiving pressurized air therebetween.

2. The tire with an inner core as recited in claim 1, wherein the outer annular edge of said annular inner core makes fluid-tight contact with the interior surface of the central portion of said resilient annular shell.

3. The tire with an inner core as recited in claim 2, wherein said annular inner core is formed from a resilient material.

4. The tire with an inner core as recited in claim 2, wherein said annular inner core is formed from a resilient material having wire reinforcement embedded therein.

5. The tire with an inner core as recited in claim 4, wherein said annular inner core is formed from rubber having wire reinforcement embedded therein.

6. The tire with an annular inner core as recited in claim 2, wherein said annular inner core has a substantially central portion having an annular channel formed therein.

7. The tire with an annular inner core as recited in claim 6, further comprising a volume of pressurized air disposed within the annular channel.

8. The tire with an inner core as recited in claim 7, wherein said annular inner core is formed from a resilient material.

9. The tire with an inner core as recited in claim 8, wherein said annular inner core is formed from resilient material having wire reinforcement embedded therein.

10. The tire with an inner core as recited in claim 9, wherein said annular inner core is formed from rubber having wire reinforcement embedded therein.

11. A tire with an inner core, comprising:
a resilient annular shell having a central portion and a pair of sidewalls extending therefrom, the central portion and the pair of sidewalls each having respective interior and exterior surfaces, the exterior surface of the central portion being adapted for contacting a road surface, the pair of sidewalls having inner annular edges adapted for fluid-tight mounting on a wheel hub; and
an annular inner core disposed within the resilient annular shell and having an inner annular edge, a pair of side annular edges, and an outer annular edge, the inner annular edge of the inner core being adapted for mounting about the wheel hub, the annular inner core being formed from a resilient material having wire reinforcement embedded therein.

12. The tire with an inner core as recited in claim 11, wherein the outer annular edge of said annular inner core contacts the interior surface of the central portion of said resilient annular shell, and the and the pair of side annular edges of the inner core contacts the pair of sidewalls of said resilient annular shell.

13. The tire with an inner core as recited in claim 12, wherein the outer annular edge of said annular inner core makes fluid-tight contact with the interior surface of the central portion of said resilient annular shell, and the pair of side annular edges of said inner core makes fluid-tight contact with the pair of sidewalls of said resilient annular shell.

14. The tire with an inner core as recited in claim 13, wherein said annular inner core has a substantially central portion having an annular channel formed therein.

15. The tire with an inner core as recited in claim 14, further comprising a volume of pressurized air disposed within the annular channel.

16. The tire with an inner core as recited in claim 15, wherein said annular inner core is formed from rubber having wire reinforcement embedded therein.

17. The tire with an inner core as recited in claim 11, wherein the pair of side annular edges of said annular inner core are spaced apart from the interior surfaces of the pair of sidewalls of said resilient annular shell, and the outer annular edge of said inner core is spaced apart from the central portion of said resilient annular shell for receiving pressurized air therebetween.

18. The tire with an inner core as recited in claim 17, wherein said annular inner core has a substantially central portion having an annular channel formed therein.

19. The tire with an inner core as recited in claim 18, further comprising a volume of pressurized air disposed within the annular channel.

20. The tire with an inner core as recited in claim 19, wherein said annular inner core is formed from rubber having wire reinforcement embedded therein.
